(19) United States
(12) Patent Application Publication
(10) Pub. No.: US 2008/0115770 A1
(43) Pub. Date: May 22, 2008

(54) Pump with torque reversal avoidance feature and engine system using same

(76) Inventor: Jack A. Merchant, Peoria, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/600,650

(22) Filed: Nov. 16, 2006

(51) Int. Cl. F02M 37/06; F04B 17/05; F04B 35/01

(52) U.S. Cl. 123/508; 417/437; 417/364

(57) ABSTRACT

A high pressure pump for a common rail fuel system avoids torque reversals in its cam shaft by applying a cyclic parasitic load. As the high pressure pump pistons transition from a pumping stroke to a retraction stroke, the cyclic parasitic loading device is loaded to avoid torque reversals in the cam shaft. The cyclic parasitic load device may include a medium pressure pump, such as for supplying medium pressure fuel to a particle trap regeneration device associated with the exhaust after treatment system.

### TECHNICAL FIELD

The present disclosure relates generally to avoiding torque reversals in pumps, and more particularly to applying a cyclic parasitic load to a high pressure fuel pump to avoid torque reversals.

### BACKGROUND

Common rail fuel systems typically utilize one or more high pressure pumps that include one or more high pressure pump pistons to supply fuel to the common rail. In addition, many of these pumps include control features, either through inlet metering or spill control, to control pressure in the common rail. This pressure control aspect is generally accomplished by controlling the volume of fluid displaced to the high pressure common rail with each reciprocation of each high pressure pump piston. In the case of an inlet metered pump, this is accomplished by restricting flow into the pumping chamber so that only the amount of fluid which will maintain the common rail at a desired pressure is allowed to enter the pumping chamber. In the case of a spill control valve, a portion of the high pressure pump piston's pumping stroke may displace fluid back to the low pressure side of the pump until a spill valve is closed, and thereafter the remaining pumping stroke displaces high pressure fuel to the common rail. In both instances, the high pressure pumping pistons are reciprocated in response to a rotating cam shaft that may include one or more cams.

Because the pumping chambers in these types of pumps will inherently have greater than zero volume when the high pressure pump piston reaches its top dead center position, the stored energy in the pressurized fuel remaining in the pumping chamber can act as a spring when the cam lobe rotates to transition the pump piston from its pumping stroke to its retraction stroke. Because of the relatively high pressures involved, the force on the back side of the cam as the retraction stroke of the pump piston begins can potentially lead to undesirable torque reversals on the pump's cam shaft. Because these types of high pressure common rail fuel pumps are often driven by a gear train coupled to an engine's crank shaft, a torque reversal can briefly relieve tooth pressure contact in the gear train, which can lead to undesirable noise when the teeth of the gear train reengage when the torque on the cam shaft again becomes positive. The noise produced in the gear train from torque reversals can lead to undesirable wear and tear on the gear train, but more importantly lead to excessive noise. Those skilled in the art will appreciate that various jurisdictions are increasingly regulating noise emissions from engine systems and their associated machines.

Co-owned U.S. Pat. No. 6,162,022 shows a variable delivery pump in which potential torque reversals are avoided by arranging three pump pistons around a rotating cam shaft in order to maintain at least one of the pump pistons in a pumping stroke at all times. This reference also shows a fixed displacement pump so that pressure control in the common rail is accomplished in another manner, such as via an electronically controlled rail pressure control valve that routes some fuel back to a lower pressure passage in order to maintain pressure in the common rail at some desired level. By maintaining one of the pumping pistons always in its pumping stroke, torque reversals can be avoided. In another example, published U.S. Patent application number 2006/0073038 shows a cam arrangement for a mechanically actuated fuel injector that avoids torque reversals by providing an asymmetrical cam whose backside surface is shaped to avoid torque reversals. Although these references teach strategies that may avoid torque reversals in some pumping configurations, asymmetrical cam shapes are not always an option, and arranging the pump pistons at different angular locations around the cam shaft may also not be an available design option in many instances.

Apart from torque reversal issues associated with a high pressure common rail fuel pump, many engine systems also include other auxiliary pump requirements that must be met. For instance, some exhaust aftertreatment systems may include an auxiliary regeneration device that utilizes a fuel dispensed into the exhaust passage to aid in regenerating a particle trap. Other pumping needs often necessary to support an engine system may include, but is not limited to, a urea pump for supplying a reductant to the exhaust aftertreatment system to chemically alter undesirable exhaust molecules into more acceptable emissions. Other requirements may include a water pump for circulating coolant to the engine system, and maybe even an air compressor for supplying pressurized air to support some aspect of a machine's operation that includes an engine system. These pumping requirements are often powered directly or indirectly by the engine, and thus it is desirable that these loads on the engine be kept to a minimum so that as much as possible of the power output of the engine can be utilized for other useful work.

The present disclosure is directed to one or more of the problems set forth above.

### SUMMARY OF THE INVENTION

In one aspect, a pump includes a rotatable cam shaft, which includes at least one cam, positioned in a pump housing. At least one pump piston is positioned in the pump housing to reciprocate in response to rotation of the cam in a pumping stroke and a retracting stroke. A cyclic parasitic load device is coupled to the cam shaft for loading in phase with a transition of the pump piston from the pumping stroke to the retracting stroke.

In another aspect, an engine system includes an engine housing that includes an exhaust passage. A fuel system includes a pump with a high pressure outlet in fluid communication with a common rail, which is in fluid communication with a plurality of fuel injectors. An exhaust aftertreatment system is in fluid communication with the exhaust passage, and includes a fuel dispenser in fluid communication with a medium pressure outlet of the pump.

In another aspect, a method of operating an engine system includes a step of reciprocating at least one high pressure pump piston in a pump housing by rotating a cam shaft. A positive torque is maintained on the cam shaft when the pump piston transitions from a pumping stroke to a retracting stroke by cyclically loading a parasitic load device coupled to the cam shaft.

### BRIEF DESCRIPTION OF THE DRAWINGS

FIG. 1 is a schematic view of an engine system according to the present disclosure;

FIG. 2 is a side sectioned view of the pump for the fuel system of FIG. 1; and

FIG. 3 is a graph of torque verses engine crank angle for the cam shaft of the pump of FIG. 2.

### DETAILED DESCRIPTION

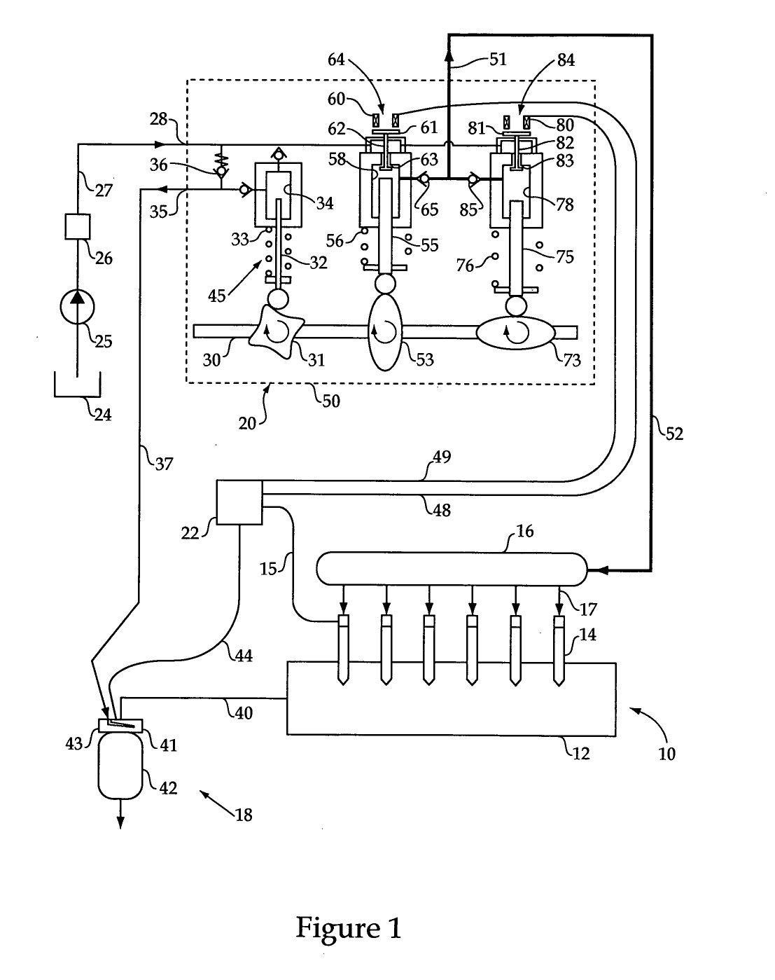

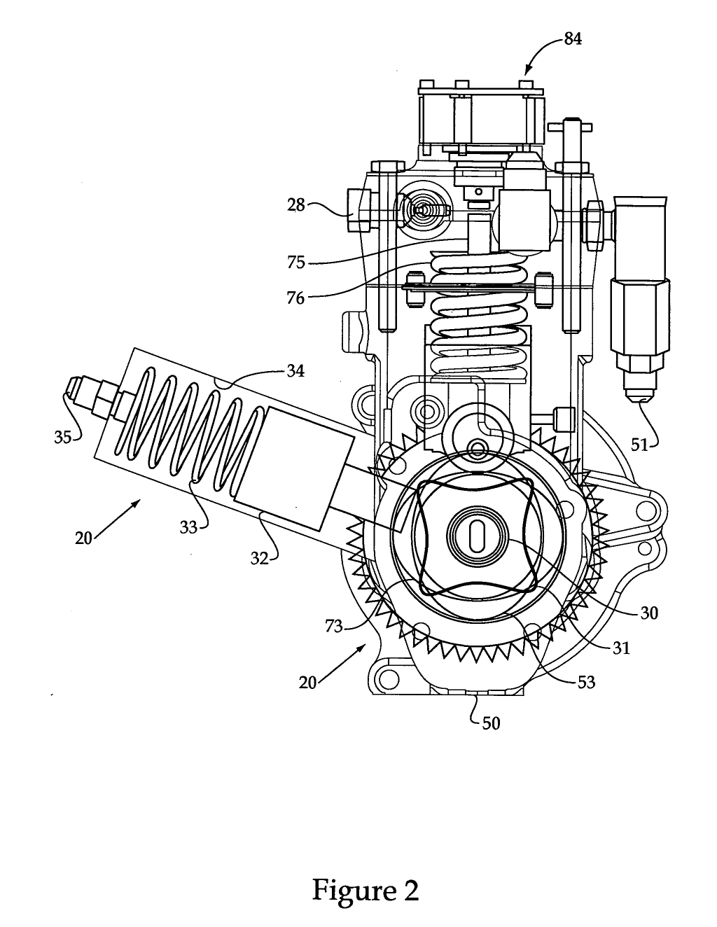

Referring to FIGS. 1 and 2, an engine system 10 includes an engine housing 12 with a plurality of fuel injectors 14 mounted therein. In particular, the illustrated embodiment shows an engine 10 with six fuel injectors 14 positioned for direct injection of liquid fuel into six separate combustion chambers. Thus, the illustrated embodiment shows a six cylinder compression ignition engine. However, those skilled in the art will appreciate that the teachings of the present disclosure are applicable to engines with more or less cylinders, and also to engines having other ignition strategies, such as spark ignition, etc. Although not necessary, fuel injectors 14 may be electronically controlled via individual communication lines 15 (only one shown) that are in communication with an electronic controller 22 in a conventional manner. Thus, electronic controller 22, with appropriate signals, controls both fuel injection timing and quantity in a manner well known in the art. In this example engine system, the fuel injectors 14 are supplied with high pressure fuel via individual branch passages 17 connected to a common rail 16. Engine system 10 may also include an exhaust aftertreatment system 18 fluidly connected to an exhaust passage 40. Although the aftertreatment system may include various components known in the art, in the illustrated embodiment, a particle trap 42 is positioned to trap particulate matter combustion products before the same could leave the tail pipe. As is known in the art, particulate traps need to be periodically regenerated, such as by oxidizing the particulate matter. In this instance, a regeneration device 41 includes a fuel dispenser 43 positioned to periodically dispense fuel to oxidize particles in particle trap 40 to regenerate the same. Regeneration device 41 is controlled by electronic controller 22 in a known manner via communication line 44.

Pressurized fuel is supplied to both common rail 16 and fuel dispenser 43 by a common pump 20. In particular, fuel dispenser 43 is fluidly connected to a medium pressure outlet 35 via a medium pressure supply line 37, while common rail 16 is fluidly connected to a high pressure outlet 51 via a high pressure supply passage 52. Although medium pressure outlet 35 and high pressure outlet 51 are shown originating from a common pump housing 50, they need not be. In particular, pump 20 may be made up of more than one pump housing that share a common cam shaft 30 that includes one or more rotating cams. Pump 20 is supplied with relatively low pressure fuel from a low pressure reservoir 24 via a conventional fuel transfer pump 25. Fuel transfer pump 25 draws low pressure fuel and supplies the same to pump inlet 28 via a fuel supply line 27 that may include a fuel filter 26.

The high pressure side of pump 20 includes a first high pressure pump piston 55 and a second high pressure pump piston 75 that reciprocate out of phase with one another in response to rotation of cam 53 and 73, respectively. Although not necessary, cams 53 and 73 may be identically shaped and symmetrical, but out of phase with one another. As shown, each of the pump pistons 55 and 75 will undergo two pumping strokes and two retraction strokes with each revolution of cam shaft 30. Pump piston 55 follows the contour of cam 53 via a return spring 56 in a conventional manner. Pump piston 55 reciprocates in a pumping chamber 58 that is fluidly connected to high pressure outlet 51 via a check valve 65. When pump piston 55 is undergoing its retracting stroke, low pressure fuel is drawn into pumping chamber 58 past a spill valve 62 and a seat 63. Those skilled in the art will recognize that the pumping chambers may be filled via a different passage without departing from the scope of this disclosure. When pumping piston 55 is undergoing its pumping stroke, fluid in pumping chamber 55 is displaced back toward the low pressure side of the pump past spill valve 62 until an electrical actuator 64 is energized to close seat 63. In particular, electrical actuator 64 may include a solenoid coil 60 and an armature 61 that is attached to spill valve member 62. When the coil 60 is energized, armature 61 and spill valve member 62 are lifted to close seat 63. Thereafter the remaining fluid displaced from pumping chamber 58 is pushed toward high pressure outlet 51 past check valve 65. Those skilled in the art will appreciate that spill valve 62 is of a latching type such that spill valve member 62 moves toward and away pumping chamber 58 with respect to seat 63. The solenoid coil 60 need only be energized briefly during a pumping stroke to close seat 63. Thereafter, the actuator can be deenergized and the high pressure in pumping chamber 58 will hold the spill valve member 62 against its seat 63 for the remainder of the pumping stroke. Electrical actuator 64 is controlled in its operation via a communication line 48 in communication with electronic controller 22. Thus, electronic controller 22 determines a desired fraction of the pumping stroke that should be utilized for displacing high pressure fuel toward common rail 16 and at an appropriate timing energizes solenoid coil 60 to close spill valve 62 to produce that requisite amount of high pressure fuel.

The pump piston 75 reciprocates out of phase with pump piston 55, and includes a return spring 76 for following the contours of cam 73. Pump piston 75 reciprocates in a pumping chamber 78 and includes a substantially identical pumping strategy. In particular, an electrical actuator 84 includes a solenoid coil 81 and an armature 81 connected to a spill valve member 82. Spill valve member 82 moves toward and away from pumping chamber 78 with respect to a seat 83. As in the other pump piston 55, electrical actuator 84 may be energized at any suitable timing during the pumping stroke via a control signal from electronic controller 22 communicated via communication line 49. The pressure in pumping chamber 78 will then hold spill valve member 82 closed so that the electrical actuator can be deenergized for the remainder of the pumping stroke. High pressure fuel displaced from pumping chamber 78 is pushed toward high pressure outlet 51 past a check valve 85 in a conventional manner.

Those skilled in the art will appreciate that the fuel remaining in the pumping chambers 58 and 78 when their respective cams 53 and 73 are at top dead center is greatly pressurized. When the pumping pistons 55 and 75 transition from their pumping stroke to their retracting stroke, that residual high pressure fuel pushes downward on the pump pistons and creates a torque on cam shaft 30 in a direction opposite to the positive torque necessary to advance the pumping pistons in their pumping strokes. If the energy and the residual fuel is sufficient, this force can actually cause the torque in cam shaft to briefly reverse as the pressure drops in the respective pumping chambers 58 and 78 at the beginning portion of each pistons retracting stroke. This torque reversal can cause the gear train (not shown) that interconnects the cam shaft 30 to the engine's crank shaft (not shown) to briefly disengage and then reengage to produce undesirable noise. The present disclosure addresses this issue by utilizing a cyclic parasitic load device 45 that is configured to be loaded during the transition of the high pressure pump piston 55 and 75 from their respective pumping strokes to their respective retracting strokes. This loading is preferably sufficient to maintain the torque on cam shaft 30 positive. In other words, the load on cam shaft 30 produced by parasitic loading device 45 may be just sufficient to cancel a portion of the negative torque originating from the respective pump pistons 45 and 75 when they transition from the pumping stroke to their retracting stroke in order to maintain a positive torque in cam shaft 30. Parasitic load device 45 could take on a wide variety of forms. One of its simplest forms could be a spring that is compressed by rotation of an additional cam 31 when the high pressure pump pistons 55 and 75 are transitioning from their pump to their retracting strokes. Those skilled in the art will appreciate that the pre-load on the spring would be sufficient to maintain a positive torque in cam shaft 30.

In the illustrated embodiment, cyclic parasitic load device 45 includes a return spring 33 and a reciprocating medium pressure pump piston 32 that respond to rotation of four lobed cam 31. The lobes of cam 31 are appropriately oriented out of phase with both cams 53 and 73 so that medium pressure pump piston 32 is in its pumping stroke when the high pressure pump pistons 55 and 75 are transitioning through their top dead center positions. Thus, medium pressure pump piston 32 undergoes four pumping strokes per revolution of cam shaft 30. Fuel is displaced from a medium pressure pumping chamber 34 past a check valve 38 toward medium pressure outlet 35. When pump piston 32 is undergoing its retracting stroke, fresh low pressure fuel is drawn into pumping chamber 34 past another check valve 39. Pressure in medium pressure supply line 35 is maintained at some desired level via a pressure regulating valve 36 that may open to return some of the pressurized fuel in supply line 37 back to low pressure fuel supply line 27 for recirculation. Thus, the present disclosure contemplates a cyclic parasitic load device 45 that may or may not be utilized to do useful work. In the illustrated embodiment, the cyclic parasitic load device is itself a medium pressure pump for supplying medium pressure fuel to a fuel dispenser 43 associated with a regeneration device 41 of an exhaust after treatment system 18. This configuration exploits the fact that both cyclic parasitic load device 45 and the high pressure pump pistons 55 and 75 utilize an identical fluid, namely fuel. Nevertheless, those skilled in the art will appreciate that other engine subsystems could also be powered or pressurized by appropriate substitution in place of the illustrated parasitic load device 45. For instance, a parasitic load device could be constructed for use with a water pump, an air compressor, a urea pump or virtually any other engine subsystem support feature that needs power or fluid flow to perform its function.

### INDUSTRIAL APPLICABILITY

The present disclosure finds potential application in any pump that includes one or more pump pistons driven to reciprocate by a rotating cam shaft. Any such pump with the potential for torque reversals could utilize a parasitic load device 45 with appropriate phasing to maintain a positive torque on the rotating cam shaft 30. Although the illustrated embodiment shows a pump 20 that includes two high pressure pump pistons 55 and 75, the teachings of the present disclosure are applicable to a pump with any number from one, two or more pump pistons that share a common cam shaft, but may be located in one or more pump housings. Those skilled in the art will appreciate that the present disclosure is particularly applicable to high pressure common rail fuel pumps where the fuel is pressurized to such high pressures that torque reversals are more likely than in most other pumping applications. Although the present disclosure illustrates a pump 20 whose high pressure output is controlled via electronically controlled spill valves, the present disclosure is equally applicable to inlet metered high pressured pumps. Finally, the present disclosure is particularly applicable to high pressure pumps that utilize symmetrically shaped cams that are typically more easy to manufacture, but potentially face torque reversal issues due to their back side cam lobe contouring.

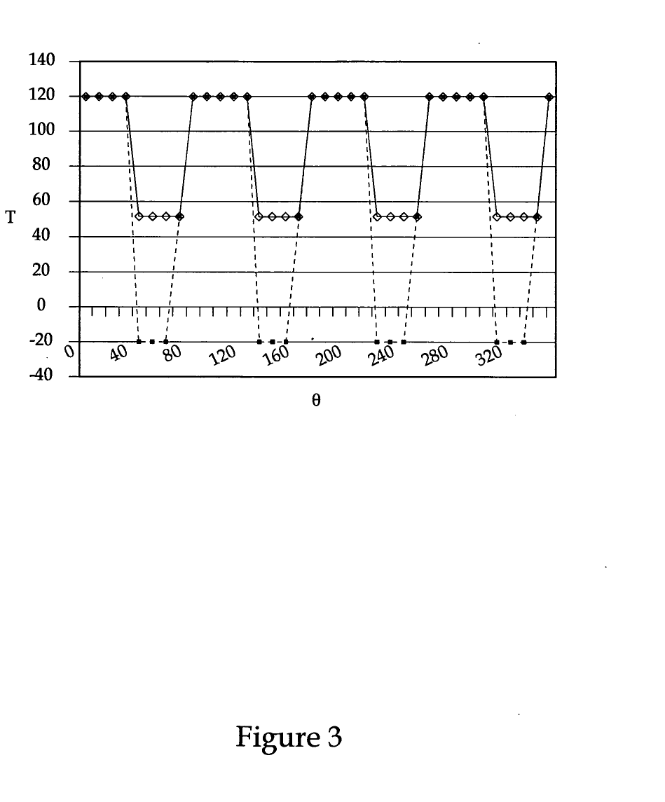

Referring now in addition to FIG. 3, an example torque signature for the pump 20 is illustrated. In particular, the torque on cam shaft 30 for one revolution is illustrated in a solid line according to the present disclosure and as a dashed line for an identical pump that does not include a parasitic load device 45 according to the present disclosure. As expected, each revolution of cam shaft 30 results in four high pressure pumping strokes. As the respective high pressure pumping strokes transition to retraction strokes, the residual pressure in the individual pumping chambers causes the torque to briefly drop to a negative value in the pump without parasitic load device 56 (dashed line), which can result in gear train disengagement and then reengagement once the torque again becomes positive, resulting in undesirable noise. However, by appropriate phasing a parasitic load device 45 as illustrated in FIGS. 1 and 2, the torque can be maintained in a positive value (solid line), which results in the gear train remaining engaged throughout each revolution of cam shaft 30. As a result, a much quieter operation is accomplished, and the parasitic load device is exploited to provide medium pressure fuel for the exhaust after treatment system 18.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A pump comprising:
a pump housing;
a rotatable cam shaft, which includes at least one cam, positioned in the pump housing;
at least one pump piston positioned in the pump housing to reciprocate in response to rotation of the cam in a pumping stroke and a retracting stroke; and
a cyclic parasitic load device coupled to the cam shaft for loading in phase with a transition of the pump piston from the pumping stroke to the retracting stroke.

2. The pump of claim 1 wherein the at least one pump piston is at least one high pressure pump piston with a high pressure displacement;
the cyclic parasitic load device includes a medium pressure pump piston with a medium pressure displacement different from the high pressure displacement, and having a pumping stroke in phase with a transition of the high pressure pump piston from its pumping stroke to its retracting stroke.

3. The pump of claim 1 including at least one low pressure inlet, a medium pressure outlet associated with the cyclic parasitic load device, and a high pressure outlet associated with the at least one pump piston.

4. The pump of claim 1 wherein the at least one pump piston is associated with the at least one cam; and
the cam shaft includes at least one additional cam associated with the parasitic load device.

5. The pump of claim 1 wherein the cyclic parasitic load device is sufficiently stiff that a torque on the cam shaft remains positive throughout each revolution of the cam shaft.

6. The pump of claim 1 wherein the at least one cam is symmetrical; and
an electronically controlled spill valve associated with each of the at least one pump piston.

7. An engine system comprising:
an engine housing that includes an exhaust passage;
a fuel system that includes a pump with a high pressure outlet in fluid communication with a common rail, which is in fluid communication with a plurality of fuel injectors;
an exhaust aftertreatment system in fluid communication with the exhaust passage and including a fuel dispenser in fluid communication with a medium pressure outlet of the pump.

8. The engine system of claim 7 wherein the pump includes at least one high pressure pump piston associated with the high pressure outlet; and
at least one medium pressure pump piston associated with the medium pressure outlet.

9. The engine system of claim 8 wherein the medium pressure pump piston has a pumping stroke in phase with a transition of the high pressure piston from a pumping stroke to a retracting stroke.

10. The engine system of claim 9 wherein the fuel dispenser is a portion of a regeneration device for a particle trap of the exhaust aftertreatment system.

11. The engine system of claim 10 wherein the pump includes an electronically controlled spill valve associated with each at least one high pressure pump piston.

12. The engine system of claim 11 wherein the pump includes a pair of high pressure pump pistons out of phase with one another.

13. The engine system of claim 12 wherein the pump includes a rotating cam shaft with separate cams associated with each of the medium pressure and high pressure pump pistons.

14. The engine system of claim 13 wherein the separate cams are symmetrical in shape.

15. A method of operating an engine system, comprising the steps of:
reciprocating at least one high pressure pump piston in a pump housing by rotating a cam shaft;
maintaining a positive torque on the cam shaft when the pump piston transitions from a pumping stroke to a retracting stroke; and
the maintaining step includes cyclically loading a parasitic load device coupled to the cam shaft.

16. The method of claim 15 including the steps of controlling a proportion of each pumping stroke that produces high pressure output by energizing an electrical actuator at a selected timing;
supplying the high pressure output to a common rail; and
supplying high pressure fuel from the common rail to individual fuel injectors.

17. The method of claim 16 wherein the parasitic load device includes at least one medium pressure pump piston that reciprocates in response to rotation of the cam shaft; and
supplying medium pressure fluid for an engine support subsystem by reciprocation of the medium pressure pump piston.

18. The method of claim 17 wherein the engine support subsystem includes an exhaust aftertreatment system that includes a regeneration device, and the medium pressure fluid is medium pressure fuel;
receiving the medium pressure fuel in the regeneration device; and
dispensing fuel from the regeneration device.

19. The method of claim 18 including a step of regenerating a particle trap of the exhaust aftertreatment system with the fuel dispensed from the regeneration device.
